(19) United States
(12) Patent Application Publication
(10) Pub. No.: US 2007/0241056 A1
(43) Pub. Date: Oct. 18, 2007

(54) Amphoteric ion exchangers for the adsorption of oxo anions

(76) Inventors: Reinhold Klipper, Koln (DE); Wolfgang Podszun, Munchen (DE); Stefan Neumann, Koln (DE); Michael Schelhaas, Koln (DE); Holger Schafer, Koln (DE); Thomas Linn, Grevenbroich (DE); Wolfgang Zarges, Koln (DE)

Correspondence Address: LANXESS CORPORATION, 111 RIDC PARK WEST DRIVE, PITTSBURGH, PA, 15275-1112, US

(21) Appl. No.: 11/732,970

(22) Filed: Apr. 5, 2007

(30) Foreign Application Priority Data
Apr. 11, 2006 (DE) 10 2006 017 371.6

(51) Int. Cl. B01D 15/00

(52) U.S. Cl. 210/660; 521/26

(57) ABSTRACT

The present invention relates to the use of amphoteric ion exchangers for adsorbing oxo anions, preferably to the use of iron oxide/iron oxyhydroxide-containing amphoteric ion exchangers for removing oxo anions from water and aqueous solutions, and to the preparation of these amphoteric iron oxide/iron oxyhydroxide-containing ion exchangers.

The present invention relates to the use of amphoteric ion exchangers for adsorbing oxo anions and their thio analogues, preferably to the use of iron oxide/iron oxyhydroxide-containing amphoteric ion exchangers for removing oxo anions from water and aqueous solutions, and to the preparation of these amphoteric iron oxide/iron oxyhydroxide-containing ion exchangers, and to a regeneration process.

### BACKGROUND OF THE INVENTION

Oxo anions in the context of the present invention have the formula XₙOₘ⁻, XₙOₘ²⁻, XₙOₘ³⁻, HXₙOₘ⁻ or H₂XₙOₘ²⁻ in which n is an integer of 1, 2, 3 or 4, m is an integer of 3, 4, 6, 7 or 13, and X is a metal or transition metal from the group of Au, Ag, Cu, Si, P, S, Cr, Ti, Te, Se, V, As, Sb, W, Mo, U, Os, Nb, Bi, Pb, Co, Ni, Fe, Mn, Ru, Re, Tc, Al, B, or a non-metal of the group of F, Cl, Br, I, CN, C, N. Preferably in accordance with the invention, the term oxo anions represents the formulae XOₘ²⁻, XOₘ³⁻, HXOₘ⁻ or H₂XOₘ²⁻, in which m is an integer of 3 or 4 and X is a metal or transition metal from the group of P, S, Cr, Te, Se, V, As, Sb, W, Mo, Bi, or a non-metal from the group of Cl, Br, I, C, N. More preferably in accordance with the invention, the term oxo anions represents oxo anions of arsenic in the (III) and (V) oxidation states, of antimony in the (III) and (V) oxidation states, of sulphur as the sulphate, of phosphorus as the phosphate, of chromium as the chromate, of bismuth as the bismuthate, of molybdenum as the molybdate, of vanadium as the vanadate, of tungsten as the tungstate, of selenium as the selenate, of tellurium as the tellurate or of chlorine as the chlorate or perchlorate. Oxo anions especially preferred in accordance with the invention are H₂AsO₃⁻, H₂AsO₄⁻, HAsO₄²⁻, AsO₄³⁻, H₂SbO₃⁻, H₂SbO₄⁻, HSbO₄²⁻, SbO₄³⁻, SeO₄²⁻, ClO₃⁻, ClO₄⁻, BiO₄²⁻, SO₄²⁻, PO₄³⁻. Very particularly preferred in accordance with the invention are the oxo anions H₂AsO₃⁻, H₂AsO₄⁻, HAsO₄²⁻ and AsO₄³⁻, and also SeO₄²⁻. In the context of the present invention, the term oxo anions also includes the thio analogues in which, instead of the O in the abovementioned formulae, S is sulphur.

The requirements on the purity of drinking water have increased significantly in the last few decades. Health authorities in numerous countries have determined limits for heavy metal concentrations in waters. This relates in particular to heavy metals such as arsenic, antimony or chromium.

Under certain conditions, for example, arsenic compounds can be leached out of rocks and hence get into the groundwater. In natural waters, arsenic occurs as an oxidic compound with tri- and pentavalent arsenic. It is found that mainly the species H₃AsO₃, H₂AsO₃⁻, H₂AsO₄⁻, HAsO₄²⁻ occur at the pH values predominating in natural waters.

In addition to the chromium, antimony and selenium compounds, readily absorbable arsenic compounds are highly toxic and carcinogenic. However, bismuth, which gets into the groundwater from ore degradation, is not uncontroversial from a health point of view.

In many regions of the USA, India, Bangladesh, China and in South America, sometimes very high concentrations of arsenic occur in the groundwater.

Numerous medical studies now demonstrate that, in humans which are exposed to high arsenic pollutions over a prolonged period, abnormal skin changes (hyperkeratoses) and various tumour types can develop as a consequence of chronic arsenic poisoning.

On the basis of medical studies, the World Health Organization WHO in 1992 recommended the worldwide introduction of a limit for arsenic in drinking water of 10 μg/l.

In many European countries and in many areas of the USA, this value is still being exceeded. Germany has complied with 10 μg/l since 1996; in EU countries, the limiting value of 10 μg/l has applied since 2003, in the USA since 2006.

Amphoteric ion exchangers contain acidic and basic groups alongside one another. Processes for their preparation are described in Helfferich, Ionenaustauscher [Ion exchangers], Volume 1, page 52, Verlag Chemie, Weinheim, or in Bolto, Pawlowski, Wastewater Treatment, Spon, London, 1986, page 5.

Useful acidic groups are preferably acrylic acid, methacrylic acid, sulphonic acid, iminodiacetic acid or phosphonic acid groups. Especially preferably, the amphoteric ion exchangers to be used in accordance with the invention have acrylic acid and/or sulphonic acid groups.

Useful basic groups preferably include primary, secondary, tertiary, quaternary amino and ammonium groups. Especially preferably, the amphoteric ion exchangers to be used in accordance with the invention have primary and/or secondary amino groups.

Stach, Angewandte Chemie, 63, 263, 1951 describes amphoteric ion exchangers which contain strongly basic and strongly acidic groups alongside one another. These amphoteric ion exchangers are prepared by copolymerizing styrene, vinyl chloride and a crosslinker, for example divinylbenzene, followed by quaternization and sulphonation.

DE-A 10353534 describes amphoteric ion exchangers which contain both weakly acidic and weakly basic groups alongside one another. The weakly basic groups mentioned are primary amino groups; the weakly acidic groups mentioned are acrylic acid and alkyl (C₁-C₄) acrylic acid groups, for example methacrylic acid.

Ion exchangers are used in a variety of ways to clean untreated waters, wastewaters and aqueous process streams. Ion exchangers are also suitable for removing oxo anions, for example arsenate. Thus, R. Kunin and J. Meyers in Journal of American Chemical Society, Volume 69, page 2874ff. (1947) describe the exchange of anions, for example arsenate, with ion exchangers which have primary, secondary and tertiary amino groups.

The removal of arsenic from drinking water with the aid of ion exchangers is also described in the monograph Ion Exchange at the Millennium, Imperial College Press 2000, page 101ff. In this case, strongly basic anion exchangers with different structural parameters, for example resins with trimethylammonium groups, known as the type I resins, based on styrene or acrylate, and resins with dimethylhydroxyethylammonium groups, known as the type II resins, were investigated.

However, a disadvantage of the known anion exchangers is that they do not have the desired and necessary selectivity and capacity for oxo anions or their thio analogues, especially toward arsenate ions. Therefore, the uptake capacity for arsenate ions in the presence of the customary anions present in drinking water is only low.

WO 2004/110623 A1 describes a process for preparing an iron oxide/iron oxyhydroxide-containing carboxyl-containing ion exchanger. This material adsorbs arsenic down to low residual concentrations but has a limited uptake capacity.

EP-A 1 568 660 discloses a process for removing arsenic from water by contacting it with a strongly basic anion exchanger which contains a specifically defined metal ion or a metal-containing ion. EP-A 1 568 660 points out that the selectivity toward arsenic rises when secondary and tertiary amino groups are converted to quaternary ammonium groups by alkylation, which, according to EP-A 1 568 660, characterizes strongly basic anion exchangers. This is because EP-A 1 568 660 designates anion exchangers which bear positive charges which are in turn associated with anions such as Cl⁻, Br⁻, F⁻ or OH⁻ as strongly basic anion exchangers. In the reverse of the statement in EP-A 1 568 660, anion exchangers with primary, secondary or tertiary amino groups are weakly basic anion exchangers. This is because strongly basic anion exchangers are obtained according to EP-A 1 568 660 solely by quaternization reaction of tertiary amine substituents.

Also disclosed is, inter alia, a process for removing arsenic from water by contacting with a strongly acidic cation exchanger which contains a specifically defined metal ion or a metal-containing ion. However, the uptake capacity is low. It is between 14 and 66 mg of As/gram of dry ion exchanger.

The arsenic adsorbers known from the prior art still do not exhibit the desired properties with regard to selectivity and capacity. There is therefore a need for novel bead-form ion exchangers or adsorbers which are specific for oxo anions, especially arsenic ions, and are simple to prepare and have improved arsenic adsorption.

### DISCLOSURE OF THE INVENTION

The solution to the problem and hence the subject-matter of the present invention is the use of amphoteric ion exchangers for adsorbing oxo anions and/or their thio analogues, preferably from water or aqueous solutions. In a preferred embodiment, the present invention relates to the use of iron oxide/iron oxyhydroxide-containing amphoteric ion exchangers for adsorbing oxo anions and/or their thio analogues from water or aqueous solutions. In a further preferred embodiment, the present invention relates to the use of iron oxide/iron oxyhydroxide-containing amphoteric ion exchangers for adsorbing oxo anions and/or their thio analogues from water or aqueous solutions which contain primary and/or secondary and/or tertiary amino groups and weakly acidic and/or strongly acidic groups.

The present invention further provides a process for preparing iron oxide/iron oxyhydroxide-containing amphoteric ion exchangers, characterized in that
a) a bead-form amphoteric anion exchanger in aqueous medium is contacted with iron(II) or iron(III) salts and
b) the suspension obtained from a) is adjusted to pH values in the range of 2.5 to 12 by adding alkali metal or alkaline earth metal hydroxides, and the resulting iron oxide/iron oxyhydroxide-containing amphoteric ion exchangers are isolated by known methods.

In view of the prior art, it was surprising that these novel iron oxide/iron oxyhydroxide-containing amphoteric ion exchangers can be prepared in a simple reaction and exhibit an oxo anion adsorption which is not only significantly improved over the prior art but is generally also suitable for use for the adsorption of oxo anions and/or their thio analogues, preferably of arsenates, antimonates, phosphates, chromates, molybdates, bismuthates, tungstates or selenates, more preferably of arsenates or antimonates of the (III) and (V) oxidation states or selenates, from aqueous solutions.

The amphoteric ion exchangers to be used as the basis in accordance with the invention for the adsorption of oxo anions may be either heterodisperse or monodisperse. Preference is given in accordance with the invention to using monodisperse amphoteric ion exchangers. Their particle size is generally 250 to 1250 μm, preferably 280-600 μm.

The monodisperse bead polymers which form the basis of the monodisperse amphoteric ion exchangers can be prepared by known processes, for example fractionation, jetting or by the seed-feed technique.

The preparation of monodisperse ion exchangers is known in principle to those skilled in the art. A distinction is drawn, aside from the fractionation of heterodisperse ion exchangers by screening, essentially between two direct preparation processes, specifically jetting and the seed-feed process in the preparation of the precursors, the monodisperse bead polymers. In the case of the seed-feed process, a monodisperse feed which can in turn be obtained, for example, by screening or by jetting is used. According to the invention, monodisperse amphoteric ion exchangers obtainable by jetting processes are preferably used for the adsorption of oxo anions.

In the present application, monodisperse refers to those bead polymers or ion exchangers in which the uniformity coefficient of the distribution curve is less than or equal to 1.2. The quotient of the d60 and d10 parameters is referred to as the uniformity coefficient. D60 describes the diameter at which 60% by mass in the distribution curve is smaller and 40% by mass is larger or of equal diameter. D10 refers to the diameter at which 10% by mass in the distribution curve is smaller and 90% by mass is larger or of equal diameter.

The monodisperse bead polymer, the precursor of the ion exchanger, can be prepared, for example, by reacting monodisperse, optionally encapsulated monomer droplets consisting of a monovinylaromatic compound, a polyvinylaromatic compound, a monovinylalkyl compound and an initiator or initiator mixture and optionally a porogen in aqueous suspension. In order to obtain macroporous bead polymers for the preparation of macroporous ion exchangers, the presence of porogen is absolutely necessary. According to the invention, it is possible to use either gel-form or macroporous monodisperse amphoteric ion exchangers. In a preferred embodiment of the present invention, monodisperse amphoteric ion exchangers are used, being manufactured from monodisperse bead polymers using microencapsulated monomer droplets. The various preparation processes for monodisperse bead polymers, both by the jetting principle and by the seed-feed principle, are known to those skilled in the art from the prior art. At this point, reference is made to US-A4,444,961, EP-A 0 046 535, U.S. Pat. No. 4,419,245 and WO 93/12167.

Preferably in accordance with the invention, the monovinylaromatic unsaturated compounds used are compounds such as styrene, vinyltoluene, ethylstyrene, alpha-methylstyrene, chlorostyrene or chloromethylstyrene.

Preferably in accordance with the invention, the monovinylically unsaturated alkyl compounds used are (meth)acrylonitrile, for example acrylonitrile, alkyl acrylates with C₁-C₄-alkyl groups, such as methyl acrylate, or alkyl (C₁-C₄)-alkyl acrylates with C₁-C₄-alkyl groups, for example methyl methacrylate.

Preference is also given to using (meth)acrylic acids.

The polyvinylaromatic compounds (crosslinkers) used are preferably divinyl-bearing aliphatic or aromatic compounds. Particular preference is given to using divinylbenzene, divinyltoluene, trivinylbenzene, ethylene glycol dimethacrylate, trimethylolpropane trimethacrylate, hexadiene-1,5, octadiene-1,7,2,5-dimethyl-1,5-hexadiene and divinyl ethers.

Suitable divinyl ethers are compounds of the general formula (I) 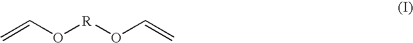
in which
R is a radical from the group of CₙH₂ₙ, (CₘH₂ₘ—O)ₚ—CₘH₂ₘ or CH₂—C₆H₄—CH₂, and n≧2, m=2 to 8 and p2≧2.

Suitable polyvinyl ethers in the case that n>2 are trivinyl ethers of glycerol, trimethylolpropane, or tetravinyl ethers of pentaerythritol.

Particular preference is given to using divinyl ethers of ethylene glycol, di-, tetra- or polyethylene glycol, butanediol or polyTHF, or the corresponding tri- or tetravinyl ethers. In particular, very particular preference is given to the divinyl ethers of butanediol and diethylene glycol, as described in EP-A 11 10 608.

The macroporous property desired as an alternative to the gel-form property is given to the ion exchangers as early as in the synthesis of their precursors, the bead polymers. The addition of so-called porogen is absolutely necessary for this purpose. The connection of ion exchangers and their macroporous structure is described in DE-B 1045102 (1957) and in DE-B 1113570 (1957). Suitable porogens for the preparation of macroporous bead polymers to be used in accordance with the invention in order to obtain macroporous amphoteric ion exchangers are in particular organic substances which dissolve in the monomer but dissolve and swell the polymer poorly. Examples include aliphatic hydrocarbons such as octane, isooctane, decane, isododecane. Also very suitable are alcohols having 4 to 10 carbon atoms, such as butanol, hexanol or octanol.

In addition to the monodisperse gel-form amphoteric ion exchangers, preference is thus given in accordance with the invention to using monodisperse amphoteric ion exchangers with macroporous structure for the adsorption of oxo anions. The term “macroporous” is known to those skilled in the art. Details are described, for example, in J. R. Millar et al., J. Chem. Soc. 1963, 218. The macroporous ion exchangers have a pore volume, determined by mercury porosimetry, of 0.1 to 2.2 ml/g, preferably of 0.4 to 1.8 ml/g.

The functionalization of the bead polymers obtainable according to the prior art to give monodisperse, amphoteric ion exchangers is likewise largely known to the person skilled in the art from the prior art.

For example, DE-A 10353534 describes a process for preparing monodisperse, macroporous, amphoteric ion exchangers having weakly basic and weakly acidic groups by the so-called phthalimide process, by
a) converting monomer droplets composed of at least one monovinylaromatic compound and at least one polyvinylaromatic compound and at least one monovinylically unsaturated acrylic compound, and also a porogen and an initiator or an initiator combination, to a monodisperse, crosslinked bead polymer,
b) amidomethylating this monodisperse, crosslinked bead polymer with phthalimide derivatives,
c) converting the amidomethylated bead polymer to an amphoteric ion exchanger having aminomethyl groups and (meth)acrylic acid groups and
d) allowing the amphoteric ion exchanger to react by alkylation to give weakly basic to strongly basic anion exchangers with secondary and/or tertiary and/or quaternary amino groups.

These bead polymers contain monovinylically unsaturated acrylic compounds, for example acrylonitrile. In the course of the functionalization according to steps b), c) and d), the acrylonitrile unit is converted to the acrylic acid group by the strongly acidic or strongly basic reaction conditions employed in the functionalization.

EP-A 107 86 88 describes the preparation of monodisperse anion exchangers by the phthalimide process. The catalyst used in the phthalimidomethylation of the monodisperse, macroporous bead polymers is oleum in a catalytically active amount. As a result of this, there is no introduction of strongly acidic sulphonic acid groups. When the amount of oleum is increased above the catalytically active amount, strongly acidic sulphonic acid groups are introduced. Catalytically active amounts of oleum are 0.05 to approx. 0.45 mol of free SO₃ per mole of phthalimide which is used to prepare the phthalimidomethylating agent. In the case of use of larger amounts of oleum, both catalytically promoted phthalimidomethylation and the introduction of strongly acidic sulphonic acid groups proceed.

To prepare amphoteric ion exchangers which contain both strongly acidic SO₃H groups and weakly basic groups, an amount of free SO₃ per mole of phthalimide of greater than 0.45 mol is therefore used. Preferably 0.5 to 2 mol of free SO₃ per mole of phthalimide, more preferably 0.8-1.5 mol of free SO₃ per mole of phthalimide, especially preferably 0.60 to 1.2 mol of free SO₃ per mole of phthalimide, are used.

SO₃ is used in the form of oleum in commercial concentration. 10% oleum to 65% oleum are commonly used.

In 10% oleum, 100 grams contain 10 grams of free SO3 and 90 grams of monosulphuric acid. In 65% oleum, 100 grams contain 65 grams of free SO₃ and 35 grams of monosulphuric acid.

According to the invention, for the adsorption of oxo anions from aqueous solutions, preference is given to monodisperse, amphoteric ion exchangers prepared by the phthalimide process. Their degree of substitution is up to 1.6, i.e. up to 1.6 hydrogen atoms are substituted by CH₂NH₂ groups on average per aromatic core. It is therefore possible by the phthalimide process to prepare high-capacity, postcrosslinking-free amphoteric ion exchangers which, after conversion to iron oxide/iron oxyhydroxide-containing amphoteric ion exchangers, are outstandingly suitable for the adsorption of oxo anions, preferably of arsenates, antimonates or selenates and/or their thio analogues, and which contain primary and/or secondary and/or tertiary amino groups and weakly acidic and/or strongly acidic groups.

The doping of the amphoteric ion exchangers to give an iron oxide/iron oxyhydroxide-containing ion exchanger is effected with iron(II) salts or iron(III) salts, and in a preferred embodiment with a non-complex-forming iron(II) salt or iron (III) salt. The iron(III) salts used in process step a) of the process according to the invention may be soluble iron(III) salts, preferably iron(III) chloride, iron(III) sulphate or iron(III) nitrate.

The iron(II) salts used may be all soluble iron(II) salts; in particular, iron(II) chloride, sulphate, nitrate are used. Preference is given to oxidizing the iron(II) salts in the suspension in process step a) by means of air.

The iron(I) salts or iron(III) salts may be used in bulk or as aqueous solutions.

The concentration of the iron salts in aqueous solution is freely selectable. Preference is given to using solutions having iron salt contents of 20 to 40% by weight.

The timing of the metered addition of the aqueous iron salt solution is uncritical. It can be done as rapidly as possible depending on the technical circumstances.

The amphoteric ion exchangers can be contacted with the iron salt solutions with stirring or by filtration in columns.

1 to 10 mol, preferably 3 to 6 mol, of alkali metal or alkaline earth metal hydroxides are used per mole of iron salt used.

0.05 to 3 mol, preferably 0.2 to 1.2 mol, of iron salt are used per mole of functional group in the ion exchanger.

The pH in process step b) is adjusted by means of alkali metal or alkaline earth metal hydroxides, especially potassium hydroxide, sodium hydroxide or calcium hydroxide, alkali metal or alkaline earth metal carbonates or hydrogencarbonates.

The pH range within which iron oxide/iron oxyhydroxide groups are formed is in the range between 2 and 12, preferably 3 and 9.

The substances mentioned are preferably used as aqueous solutions.

The concentration of the aqueous alkali metal hydroxide or alkaline earth metal hydroxide solutions may be up to 50% by weight. Preference is given to using aqueous solutions having an alkali metal hydroxide or alkaline earth metal hydroxide concentration in the range of 20 to 40% by weight.

The rate of the metered addition of the aqueous solutions of alkali metal or alkaline earth metal hydroxide depends upon the magnitude of the desired pH and the technical circumstances. For example, 120 minutes are required for this purpose.

On attainment of the desired pH, the mixture is stirred for a further 1 to 10 hours, preferably 2 to 4 hours.

The metered addition of the aqueous solutions of alkali metal or alkaline earth metal hydroxide is effected at temperatures between 10 and 90° C., preferably at 30 to 60° C. 0.5 to 3 ml of deionized water are used per millilitre of amphoteric ion exchange resin in order to achieve good stirrability of the resin.

Without proposing a mechanism for the present application, FeOOH compounds which bear freely accessible OH groups on the surface are probably formed in process step b) by virtue of the pH change in the pores of the ion exchange resins. Oxo anions, preferably arsenic, are then probably removed via an exchange of OH⁻ for, for example, HAsO₄²⁻ or H₂AsO₄⁻ to form an AsO—Fe bond.

According to the invention, preference is given to using NaOH or KOH as the base in the synthesis of the iron oxide/iron oxyhydroxide-containing amphoteric ion exchanger. However, it is also possible to use any other base which leads to the formation of FeOH groups, for example NH₄OH, Na₂CO₃, CaO, Mg(OH)₂, etc.

Isolation in the context of the present invention means, in preparation process step b), removal of the ion exchanger from the aqueous suspension and purification thereof. The removal is effected by measures known to those skilled in the art, such as decanting, centrifugation, filtration. The purification is effected by washing with, for example, deionized water and may include a classification to remove fines or coarse fractions. The resulting iron oxide/iron oxyhydroxide-containing amphoteric ion exchanger can optionally be dried, preferably by means of reduced pressure and/or more preferably at temperatures between 20° C. and 180° C.

Surprisingly, the inventive amphoteric ion exchangers adsorb not only oxo anions and/or their thio analogues, for example of arsenic in its wide variety of forms, but also additionally heavy metals, for example cobalt, nickel, lead, zinc, cadmium, copper. Preferably in accordance with the invention, the object is achieved by the iron oxide/iron oxyhydroxide-containing amphoteric ion exchangers.

As already described above, ions equally capable of ion exchange by means of the amphoteric ion exchangers to be used in accordance with the invention are also ions isostructural to HAsO₄²⁻ or H₂AsO₄⁻, for example dihydrogenphosphates, vanadates, molybdates, tungstates, antimonates, bismuthates, selenates or chromates. The amphoteric ion exchangers to be synthesized in accordance with the invention are especially preferably suitable for the adsorption of the species H₂AsO₃⁻, H₂AsO₄⁻, HAsO₄²⁻, AsO₄³⁻, H₂SbO₃⁻, H₂SbO₄⁻, HSbO₄²⁻, SbO₄³⁻, SeO₄²⁻.

The amphoteric ion exchangers to be used in accordance with the invention, preferably the iron oxide/iron oxyhydroxide-containing amphoteric ion exchangers, can be used to purify waters of any type which contain oxo anions and their thio analogues, preferably drinking water, wastewater streams of the chemical industry or of refuse incineration plants, and of pit waters or leachate waters of landfill sites.

The amphoteric ion exchangers to be used in accordance with the invention, preferably the inventive iron oxide/iron oxyhydroxide-containing amphoteric ion exchangers, are preferably used in apparatus suitable for their tasks.

The invention therefore also relates to apparatus which can be flowed through by a liquid to be treated, preferably filtration units, more preferably adsorption vessels, especially filter adsorption vessels, filled with the amphoteric ion exchangers, preferably with iron oxide/iron oxyhydroxide-containing amphoteric ion exchangers obtainable by the process described in this application, for the removal of oxo anions and their thio analogues, preferably for the removal of arsenic, antimony or selenium, especially of arsenic, from aqueous media or gases, preferably drinking water. The apparatus may be attached to the sanitary and drinking water supply, for example, in the household.

It has been found that the amphoteric ion exchangers, preferably the iron oxide/iron oxyhydroxide-containing amphoteric ion exchangers, can be regenerated easily by alkaline sodium chloride solutions. The present invention therefore also provides a regeneration process for amphoteric ion exchangers, preferably iron oxide/iron oxyhydroxide-containing amphoteric ion exchangers, characterized in that an alkaline sodium chloride solution is allowed to act on them. This sodium chloride solution preferably has a content of sodium chloride of 0.1 to 10% by weight, more preferably of 1 to 3% by weight, and a pH of 6 to 13, preferably of 8 to 11, more preferably of 9 to 10. In a preferred embodiment of the inventive regeneration, the regenerated adsorber is additionally treated with dilute, preferably 1-10% by weight, mineral acids, especially preferably with sulphuric acid or hydrochloric acid.

Analysis Methods

Determination of the Uptake Capacity for Arsenic in the V Oxidation State:

To measure the adsorption of arsenic(V), 250 ml of an aqueous solution of Na2HAsO4 with an amount of As(V) of 2800 ppb are adjusted to a pH of 8.5 and agitated with 0.3 ml of arsenic adsorber in a 300 ml polyethylene bottle for 24 hours. After 24 hours, the remaining amount of arsenic(V) in the supernatant solution is analysed.

Determination of the Amount of Basic Aminomethyl Groups in the Aminomethylated Crosslinked Polystyrene Bead Polymer

100 ml of the aminomethylated bead polymer are compacted by shaking on a tamping volumeter and then flushed into a glass column with demineralized water. Within 1 hour and 40 minutes, 1000 ml of 2% by weight sodium hydroxide solution are filtered through. Subsequently, demineralized water is filtered through until 100 ml of eluate admixed with phenolphthalein have a consumption of 0.1N (0.1 normal) hydrochloric acid of at most 0.05 ml.

50 ml of this resin are admixed in a beaker with 50 ml of demineralized water and 100 ml of 1N hydrochloric acid. The suspension is stirred for 30 minutes and then transferred to a glass column. The liquid is discharged. A further 100 ml of 1N hydrochloric acid are filtered through the resin within 20 minutes. Subsequently, 200 ml of methanol are filtered through. All eluates are collected and combined and titrated with 1N sodium hydroxide solution against methyl orange.

The amount of aminomethyl groups in 1 litre of aminomethylated resin is calculated by the following formula: (200−V)·20=mol of aminomethyl groups per litre of resin, in which V represents volume of the 1N sodium hydroxide solution consumed in the titration.

Determination of the Degree of Substitution of the Aromatic Cores of the Crosslinked Bead Polymer by Aminomethyl Groups

The amount of aminomethyl groups in the total amount of the aminomethylated resin is determined by the above method.

The molar amount of aromatics present in this amount is calculated from the amount of bead polymer used—A in grams—by division by the molecular weight.

For example, 950 ml of aminomethylated bead polymer with an amount of 1.8 mol/l of aminomethyl groups are prepared from 300 grams of bead polymer.

950 ml of aminomethylated bead polymer contain 2.82 mol of aromatics.

1.8/2.81=0.64 mol of aminomethyl groups are then present per aromatic.

The degree of substitution of the aromatic cores of the crosslinked bead polymer by aminomethyl groups is 0.64.

Determination of the Amount of Strongly Acidic Groups

Sulphonic acid groups are present as strongly acidic groups. Their amount is determined by elemental analysis determination of the sulphur content of the amphoteric ion exchanger or by titration of the groups.

50 ml of amphoteric ion exchanger are transferred into a column. Within 2 hours, 200 ml of 4% by weight sulphuric acid are filtered through. This is followed by washing with 1000 ml of demineralized water.

20 ml of this resin mass are removed and transferred to a sample beaker. 50 ml of demineralized water are metered in. The suspension is stirred. A further 90 ml of demineralized water and 5 grams of sodium chloride are metered in. The suspension is stirred for 15 minutes. Subsequently, titration is effected with 1N sodium hydroxide solution to pH 4.3.

The resin is filtered off and washed with 100 ml of demineralized water, and its volume is determined. This is the volume in the sodium form.

Consumption of 1N sodium hydroxide solution/20=total capacity of the H form in mol of strongly acidic groups/litre of resin.

Number of Perfect Beads after Production

100 beads are examined under the microscope. The number of beads which have cracks or exhibit fractures is determined. The number of perfect beads results from the difference in the number of damaged beads from 100.

Determination of Resin Stability by the Roller Test

The bead polymer under test is distributed in a uniform layer thickness between two plastic cloths. The cloths are laid on a solid horizontally mounted support and subjected in a roller apparatus to 20 operating cycles. An operating cycle consists of a rolling carried out to and fro. After the rolling, the number of undamaged beads is determined on representative samples of 100 beads by enumeration under the microscope.

Swelling Stability Test

25 ml of resin in the chloride from are packed into a column. In succession, 4% strength by weight aqueous sodium hydride solution, demineralised water, 6% strength by weight hydrochloric acid and again demineralised water are applied to the column, the sodium hydroxide solution and the hydrochloric acid flowing through the resin from the top and the demineralised water being pumped through the resin from the bottom. The treatment proceeds under time control via a controller. One operating cycle lasts 1 h. 20 operating cycles are carried out. After the end of the operating cycles, 100 beads of the resin sample are counted out. The number of perfect beads which are not damaged by cracks of fractures is determined.

Determination of the Amount of Weakly and Strongly Basic Groups in Anion Exchanges

100 ml of anion exchanger are charged in a glass column in the course of 1 hour and 40 minutes with 1000 ml of 2% strength by weight sodium hydroxide solution. The resin is then washed with deionized water to remove the excess of sodium hydroxide solution.

Determination of the NaCl Number

50 ml of the exchanger in the free base form and washed to neutrality are placed in a column and charged with 950 ml of 2,5% strength by weight aqueous sodium chloride solution. The effluent is collected, made up to 1 litre with deionized water and of this 50 ml titrated with 0.1 n (=0.1 normal) hydrochloric acid. The resin is washed with deionized water.

ml of 0.1 n hydrochloric acid consumed·4/100=NaCl number in mol/l of resin.

Determination of the NaNO₃ Number

950 ml of 2.5% strength by weight sodium nitrate solution are then filtered through. The effluent is made up to 1000 ml with deionized water. Of this one aliquot, 10 ml, is taken off and analysed for its chloride content by titration with mercury nitrate solution.

ml of Hg (NO₃) solution consumed·factor/17.75=NaNO₃ number in mol/litre of resin.

Determination of the HCl Number

The resin is washed with deionized water and flushed into a glass beaker. 100 ml of 1 n hydrochloric acid are added and the mixture is allowed to stand for 30 minutes. The entire suspension is flushed into a glass column. A further 100 ml of hydrochloric acid are filtered through the resin. The resin is washed with methanol. The effluent is made up to 1000 ml with deionized water. Of this 50 ml are titrated with 1 n of sodium hydroxide solution.

(20-ml of 1 n sodium hydroxide solution consumed)/5=HCl number in mol/litre of resin.

The amount of strongly basic groups is equal to the sum of NaNO₃ number and HCl number.

The amount of weakly basic groups is equal to the HCl number.

It will be understood that the specification and examples are illustrative but not limitative of the present invention and that other embodiments within the spirit and scope of the invention will suggest themselves to those skilled in the art.

### EXAMPLE 1

1a) Preparation of a Monodisperse Macroporous Bead Polymer Based on Styrene, Divinylbenzene and Ethylstyrene

A 10 l glass reactor was initially charged with 3000 g of demineralized water, and a solution of 10 g of gelatin, 16 g of disodium hydrogenphosphate dodecahydrate and 0.73 g of resorcinol in 320 g of deionized water was added and mixed. The mixture was adjusted to 25° C. With stirring, a mixture of 3200 g of microencapsulated monomer droplets with narrow particle size distribution, composed of 3.6% by weight of divinylbenzene and 0.9% by weight of ethylstyrene (used in the form of a commercial isomer mixture of divinylbenzene and ethylstyrene with 80% divinylbenzene), 0.5% by weight of dibenzoyl peroxide, 56.2% by weight of styrene and 38.8% by weight of isododecane (technical isomer mixture with high proportion of pentamethylheptane) was then added, the microcapsules consisting of a formaldehyde-hardened complex coacervate of gelatin and a copolymer of acrylamide and acrylic acid, and 3200 g of aqueous phase with a pH of 12 were added. The mean particle size of the monomer droplets was 460 μm.

The mixture was polymerized to completion with stirring by temperature increase according to a temperature programme beginning at 25° C. and ending at 95° C. The mixture was cooled, washed through a 32 μm screen and then dried at 80° C. under reduced pressure. 1893 g of a bead-form polymer with a mean particle size of 440 μm, narrow particle size distribution and smooth surface were obtained.

Viewed from above, the polymer was chalky white and had a bulk density of approx. 370 g/l.

1b) Preparation of an Amidomethylated Bead Polymer

At room temperature, 3567 g of dichloroethane, 867 g of phthalimide and 604 g of 29.8% by weight formalin were initially charged. The pH of the suspension was adjusted to 5.5 to 6 with sodium hydroxide solution. Subsequently, the water was removed by distillation. 63.5 g of sulphuric acid were then metered in. The water formed was removed by distillation. The mixture was cooled. At 30° C., 232 g of 65% oleum and then 403 g of monodisperse bead polymer prepared by process step 1a) were metered in. The suspension was heated to 70° C. and stirred at this temperature for a further 6 hours. The reaction slurry was drawn off, demineralized water was added and residual amounts of dichloroethane were removed by distillation.

Yield of amidomethylated bead polymer: 2600 ml

Elemental Analysis Composition:

carbon: 74.9% by weight;

hydrogen: 4.6% by weight;

nitrogen: 6.0% by weight;

remainder: oxygen.

1c) Preparation of an Aminomethylated Bead Polymer

624 g of 50% by weight sodium hydroxide solution and 1093 ml of demineralized water were metered at room temperature into 1250 ml of amidomethylated bead polymer from 1b). The suspension was heated to 180° C. within 2 hours and stirred at this temperature for 8 hours. The resulting bead polymer washed with demineralized water.

Yield of aminomethylated bead polymer: 1110 ml

The total yield—extrapolated—was found to be 2288 ml.

Elemental Analysis Composition:

nitrogen: 12.6% by weight;

carbon: 78.91% by weight;

hydrogen: 8.5% by weight.

It can be calculated from the elemental analysis composition of the aminomethylated bead polymer that, on average, 1.34 hydrogen atoms per aromatic core—stemming from the styrene and divinylbenzene units—have been substituted by aminomethyl groups.

Determination of the amount of basic groups: 2.41 mol/litre of resin

1d) Preparation of a Bead Polymer with Tertiary Amino Groups

A reactor was initially charged with 1380 ml of demineralized water, 920 ml of aminomethylated bead polymer from 1c) and 490 g of 29.7% by weight formalin solution at room temperature. The suspension was heated to 40° C. The pH of the suspension was adjusted to pH 3 by metering in 85% by weight formic acid. Within 2 hours, the suspension was heated to reflux temperature (97° C.). During this time, the pH was kept at 3.0 by metering in formic acid. On attainment of the reflux temperature, the pH was adjusted to 2 initially by metering in formic acid, then by metering in 50% by weight sulphuric acid. The mixture was stirred at pH 2 for 30 minutes. Further 50% by weight sulphuric acid was then metered in, and the pH was adjusted to 1. At pH 1 and reflux temperature, the mixture was stirred for a further 8.5 hours.

The mixture was cooled, and the resin was filtered off on a sieve and washed with demineralized water.

Volume yield: 1430 ml

In a column, 2500 ml of 4% by weight aqueous sodium hydroxide solution were filtered through the resin. It was then washed with water.

Volume yield: 1010 ml

Elemental Analysis Composition:

nitrogen: 12.4% by weight;

carbon: 76.2% by weight;

hydrogen: 8.2% by weight;

determination of the amount of basic groups: 2.22 mol/litre of resin

### EXAMPLE 2

Preparation of an Amphoteric Ion Exchanger with Weakly Basic and Weakly Acidic Groups

2a) Preparation of a Monodisperse Macroporous Bead Polymer Based on Styrene, Divinylbenzene, Ethylstyrene and Acrylonitrile

Based on the total amount of monomers, the monomer mixture contained 3% by weight of acrylonitrile.

A 10 l glass reactor was initially charged with 3000 g of demineralized water, and a solution of 10 g of gelatin, 16 g of disodium hydrogenphosphate dodecahydrate and 0.73 g of resorcinol in 320 g of deionized water was added and mixed. 53 grams of acrylonitrile were metered in. The mixture was adjusted to 25° C. With stirring, a mixture of 3200 g of microencapsulated monomer droplets with narrow particle size distribution, composed of 3.6% by weight of divinylbenzene and 0.9% by weight of ethylstyrene (used in the form of a commercial isomer mixture of divinylbenzene and ethylstyrene with 80% divinylbenzene), 0.5% by weight of dibenzoyl peroxide, 56.2% by weight of styrene and 38.8% by weight of isododecane (technical isomer mixture with high proportion of pentamethylheptane) was then added, the microcapsules consisting of a formaldehyde-hardened complex coacervate of gelatin and a copolymer of acrylamide and acrylic acid, and 3200 g of aqueous phase with a pH of 12 were added. The mean particle size of the monomer droplets was 460 μm.

The mixture was polymerized to completion with stirring by temperature increase according to a temperature programme beginning at 25° C. and ending at 95° C. The mixture was cooled, washed through a 32 μm screen and then dried at 80° C. under reduced pressure. 1950 g of a bead-form polymer with a mean particle size of 440 μm, narrow particle size distribution and smooth surface were obtained.

Viewed from above, the polymer was chalky white and had a bulk density of approx. 370 g/l.

The nitrogen content of the polymer is 0.9% by weight.

Yield of bead polymer: 1950 grams based on the total amount of monomers, which means 99.5% by weight yield.

2b) Preparation of an Amidomethylated Bead Polymer

At room temperature, 634 ml of dichloroethane, 235.2 g of phthalimide and 165.4 g of 29.6% by weight formalin were initially charged. The pH of the suspension was adjusted to 5.5 to 6 with sodium hydroxide solution. Subsequently, the water was removed by distillation. 17.3 g of sulphuric acid were then metered in. The water formed was removed by distillation. The mixture was cooled. At 30° C., 68.3 g of 65% oleum and then 242.2 g of monodisperse bead polymer prepared by process step 2a) were metered in. The suspension was heated to 70° C. and stirred at this temperature for a further 6 hours. The reaction slurry was drawn off, demineralized water was added and residual amounts of dichloroethane were removed by distillation.

Yield of amidomethylated bead polymer: 1100 ml

50 ml of resin, after compacting by shaking, weigh 20.2 grams dry.

Elemental Analysis Composition:

carbon: 77.9% by weight;

hydrogen: 5.2% by weight;

nitrogen: 5.0% by weight;

remainder: oxygen.

2c) Preparation of an Amphoteric Ion Exchanger with Weakly Acidic and Weakly Basic Groups

379 g of 50% by weight sodium hydroxide solution and 1024 ml of demineralized water at room temperature were metered into 1060 ml of amidomethylated bead polymer from 2b). The suspension was heated to 180° C. within 2 hours and stirred at this temperature for 8 hours. The resulting bead polymer washed with demineralized water.

Yield of aminomethylated bead polymer: 740 ml

Elemental Analysis Composition:

nitrogen: 7.3% by weight;

carbon: 81.2% by weight;

hydrogen: 7.7% by weight.

It can be calculated from the elemental analysis composition of the aminomethylated bead polymer that, on average, 0.66 hydrogen atom per aromatic core—stemming from the styrene and divinylbenzene units—has been substituted by aminomethyl groups.

Determination of the amount of basic groups: 1.40 mol/litre of resin

Determination of the amount of weakly acidic groups: 0.08 mol/litre of resin

2d) Preparation of an Amphoteric Ion Exchanger with Weakly Acidic and Strongly Basic Groups

An autoclav was initially charged at room temperature with 700 ml aminomethylated bead polymer from Example 2b) and 1177 ml demineralised water. Thereafter 216 ml 50% by weight of sodium hydroxide solution and 319 ml chlormethane were metered in. The mixture was heated up to 40° C. and stirred at that temperature for 16 hours.

The mixture was cooled to room temperature. Subsequently, the resin was placed on a sieve and washed with demineralised water. Placed on a glass column the resin was then further washed with 300 ml 5% by weight of sodium chloride solution.

The resin was then further purified by flushing from the bottom with air and for removing soluble impurities and smaller particles it was classified with water.

Volume yield: 1070 ml

NaCl number: 0,536 mol/l

NaNO₃ number: 1,292 mol/l

HCl number: 0,118 mol/l

Original stability: 97% perfect beads

resin stability by the roller test: 95% perfect beads

swelling stability: 90% perfect beads

### EXAMPLE 3

Preparation of an Amphoteric Ion Exchanger with Weakly Basic and Strongly Acidic Groups

3a) Preparation of an Amidomethylated Bead Polymer

At room temperature, 1212 ml of dichloroethane, 451 g of phthalimide and 317 g of 29.8% by weight formalin were initially charged. The pH of the suspension was adjusted to 5.5 to 6 with sodium hydroxide solution. Subsequently, the water was removed by distillation. 33 g of sulphuric acid were then metered in. The water formed was removed by distillation. The mixture was cooled. At 30° C., 245 g of 65% oleum and then 186 g of monodisperse bead polymer prepared by process step 1a) were metered in. The suspension was heated to 70° C. and stirred at this temperature for a further 6 hours.

The reaction slurry was drawn off, demineralised water was added and residual amounts of dichloroethane were removed by distillation.

Yield of amidomethylated bead polymer: 1420 ml

Elemental Analysis Composition:

carbon: 70.7% by weight;

hydrogen: 4.3% by weight;

nitrogen: 6.3% by weight;

sulphur: 0.2% by weight.

50 ml of moist resin weigh 21.8 grams in dried form.

3b) Preparation of an Aminomethylated Bead Polymer

677 g of 50% by weight sodium hydroxide solution and 1226 ml of demineralised water were metered at room temperature into 1390 ml of amidomethylated bead polymer from 3a). The suspension was heated to 180° C. within 2 hours and stirred at this temperature for 8 hours. The resulting bead polymer washed with demineralised water.

Yield of aminomethylated bead polymer: 1120 ml

Elemental Analysis Composition:

nitrogen: 12.7% by weight

carbon: 67.5% by weight

hydrogen: 7.6% by weight

sulphur: 1.8% by weight

30 ml of resin weigh 7.276 grams in dry form

It can be calculated from the elemental analysis composition of the aminomethylated bead polymer that, on average, 1.15 hydrogen atoms per aromatic core—stemming from the styrene and divinylbenzene units—have been substituted by aminomethyl groups.

Determination of the amount of basic groups: 2.01 mol/litre of resin

Determination of the amount of strongly acidic groups: 0.15 mol/litre of resin

3c) Preparation of an Amphoteric Ion Exchanger with Strongly Acidic and Strongly Basic Groups

An autoclav was initially charged at room temperature with 550 ml aminomethylated bead polymer from Example 2b) and 937 ml demineralised water. Thereafter 173 ml 50% by weight of sodium chloride solution.

This resis was then further purified by flushing from the bottom with air and for removing soluble inpurities and smaller particles it was classified with water.

Volume yield: 875 ml

NaCl number: 0,620 mol/l

NaNO₃ number: 1,115 mol/l

HCl number: 0,09 mol/l

Original stability: 96% perfect beads

Resin stability by the roller text: 92% perfect beads

Swelling stability: 92% perfect beads

### EXAMPLE 4

Preparation of an Oxo Anion Exchanger Based on an Amphoteric Ion Exchanger with Weakly Basic and Weakly Acidic Groups

210 ml of demineralized water and 350 ml of aminomethylated bead polymer from Example 2c) were initially charged in a glass column (length 50 cm, diameter 12 cm). 227 ml of 40% by weight aqueous iron(III) sulphate solution were introduced from the top within 2 hours. Subsequently, air was passed through the suspension from the bottom in such a way that the resin was swirled. During the entire precipitation and loading operation, air swirling was continued. The suspension exhibited a pH of 1.5. With swirling, 50% by weight of sodium hydroxide solution was metered in from the top. The pH of the suspension was adjusted stepwise to 3.0:3.5:4.0:4.5:5.0:5.5:6.0:6.5:7.0. On attainment of the pH steps, swirling was continued in each case for a further 15 minutes. On attainment of pH 7.0, swirling was continued at this pH for a further hour. On attainment of pH 3.5, a further 200 ml of demineralized water were metered in. Subsequently, the resin was placed on a sieve and washed with demineralized water. The resin was then further purified by flushing from the bottom with demineralized water in a glass column for 2 hours and classifying.

Consumption of 50% by weight sodium hydroxide solution: 78 ml

Volume yield: 440 ml

100 ml of resin weigh in dried form: 35.85 grams

Bead diameter: 340μ.

### EXAMPLE 5

Preparation of an Oxo Anion Exchanger Based on an Amphoteric Ion Exchanger with Weakly Basic and Strongly Acidic Groups

159 ml of demineralized water and 265 ml of aminomethylated bead polymer from Example 3b) were initially charged in a glass column (length 50 cm, diameter 12 cm). 262 ml of 40% by weight aqueous iron(III) sulphate solution were introduced from the top within 2 hours. Subsequently, air was passed through the suspension from the bottom in such a way that the resin was swirled. During the entire precipitation and loading operation, air swirling was continued. The suspension exhibited a pH of 1.5. With swirling, 50% by weight of sodium hydroxide solution was metered in from the top. The pH of the suspension was adjusted stepwise to 3.0:3.5:4.0:4.5:5.0. On attainment of the pH steps, swirling was continued in each case for a further 15 minutes. On attainment of pH 5.0, swirling was continued at this pH for a further 2 hours. On attainment of pH 3.5, a further 300 ml of demineralized water were metered in. Subsequently, the resin was placed on a sieve and washed with demineralized water. The resin was then further purified by flushing from the bottom with demineralized water in a glass column for 2 hours and classifying.

Consumption of 50% by weight sodium hydroxide solution: 88 ml

Volume yield: 260 ml

100 ml of resin weigh in dry form: 45.02 grams

Iron content: 17% by weight

Sodium content: 12 mg/kg

1. A process for adsorbing oxo anions and/or their thio analogues from water or their aqueous solutions, wherein amphoteric ion exchangers are used.

2. A process according to claim 1, wherein the amphoteric ion exchangers comprise iron oxide/iron oxyhydroxide.

3. A process according to claim 1, wherein the ion exchangers to be used are monodisperse.

4. A process according to claim 3, wherein the monodisperse ion exchangers to be used are macroporous.

5. A process according to claim 3, wherein the precursor of the monodisperse ion exchanger is prepared by a jetting process.

6. A process according to claim 1, wherein oxo anions of the formulae XₙOₘ⁻, XₙOₘ²⁻, XₙOₘ³⁻, HXₙOₘ⁻ or H₂XₙOₘ²⁻ in which n is an integer of 1, 2, 3 or 4, m is an integer of 3, 4, 6, 7 or 13, and X is a metal or transition metal from the group of Au, Ag, Cu, Si, P, S, Cr, Ti, Te, Se, V, As, Sb, W, Mo, U, Os, Nb, Bi, Pb, Co, Ni, Fe, Mn, Ru, Re, Tc, B, Al, or a non-metal of the group of F, Cl, Br, I, CN, C, N are adsorbed.

7. A process according to claim 1, wherein the amphoteric ion exchangers contain primary and/or secondary and/or tertiary amino groups and weakly acidic and/or strongly acidic groups.

8. A process according to claim 1, wherein the waters to be cleaned are wastewater streams from the chemical industry or from refuse incineration plants, pit water or leachate water from landfill sites.

9. A method of use according to claim 1, wherein the amphoteric ion exchangers are used in apparatus which can be flowed through by the liquid to be treated.

10. A process for preparing iron oxide/iron oxyhydroxide-containing amphoteric ion exchangers, wherein
a) a bead-form amphoteric ion exchanger in aqueous medium is contacted with iron(II) or iron(III) salts and
b) the mixture obtained from a) is adjusted to pH values in the range of 2.5 to 12 by adding alkali metal or alkaline earth metal hydroxides, and the resulting iron oxide/iron oxyhydroxide-containing ion exchangers are isolated by known methods.

11. A regeneration process for amphoteric ion exchangers wherein an alkaline sodium chloride solution is allowed to act on them after they have been loaded with oxo anions and/or their thio analogues.

12. A regeneration process according to claim 11, wherein the regenerated adsorber is additionally treated with dilute mineral acids.

13. A regeneration process according to claim 11, wherein the amphoteric ion exchanger is an iron oxide/iron oxyhydroxide-containing ion exchanger.

14. A regeneration process according to claim 13, wherein the amphoteric iron oxide/iron oxy hydroxide containing ion exchanger is additionally treated with dilute mineral acids.
